(19) United States
(12) Patent Application Publication
(10) Pub. No.: US 2008/0288284 A1
(43) Pub. Date: Nov. 20, 2008

(54) Remote Diagnostics for In-Home Audio Video Gear

(75) Inventors: Robert C. Leichner, Menlo Park, CA (US); Daniel A. Simms, Sunnyvale, CA (US); David S. Moberly, Palo Alto, CA (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/093,777

(22) PCT Filed: Oct. 17, 2006
(86) PCT No.: PCT/IB2006/053825

§ 371 Date: May 15, 2008

Related U.S. Application Data
(60) Provisional application No. 60/738,104, filed on Nov. 17, 2005.

(51) Int. Cl. G06Q 50/00; G06F 17/00; G06F 3/00

(52) U.S. Cl. 705/2; 700/94; 710/8

(57) ABSTRACT

A first station (12, 16) at least sends audio/visual content to audio/visual devices (50, 92). A user interface (50) displays audio/visual content received from the first station (12, 16) when the audio/visual devices (50, 92) are properly configured. A control device (52, 120) communicates with the audio/visual devices (50, 92) to adjust the audio/visual devices configurations to display the received audio/visual content on the user interface (50).

The following relates to the health management arts. It finds particular application in conjunction with the remote diagnostics of the outpatient health monitoring systems. It also finds application in remote diagnostics of the home entertainment and other audio/visual systems, and the like.

The outpatient or remote health care management system typically connects chronically ill patients and health care providers via interactive health care communication platform, which, for example, uses the patient's home television sets. The patients use the medical devices, which are installed in their homes, to measure vital signs such as blood pressure, heart rate and weight. The patients biometric data is automatically sent via secured television connection links to the supervising health care providers. The health care providers monitor the patients health by setting up the flags for clinical reviews if one of the vital sign measurements falls outside the normal range. In addition, the health care professionals can support the patients by sending them reminders, educational videos, and the like. The patients access such materials through the home television set.

Oftentimes, the technical problems arise after the health care management system is installed in the patient's home. The problems are typically caused by an incorrectly selected transmission channel, incorrectly selected device, and the like. Such problems are easy to fix, e.g. push a correct button or switch to a correct mode. However, the vast majority of chronically ill patients is not particularly well-versed in the electronic equipment. In addition, many of the patients are older people and some are of diminished capacity.

Although the problems are visible at the patient's home, the problems are not visible at the health care provider site. One approach to diagnose and fix the technical problems is via the telephone. After the patient describes the problem, the service technician can attempt to guide the patient through various tests and settings of the patient equipment. This approach is neither effective, nor efficient due to the patients pool as described above.

Another approach to address the problems is by a home visit of the service person. The service person needs to be the one who knows the system configuration. Such solution is associated with the scheduling conflicts, increased costs and time spent for the remote health care system maintenance.

There is a need for methods and apparatuses that overcome at least some of the shortcomings described above.

According to one aspect, a health management system is disclosed. A first station at least sends audio/visual content to audio/visual devices. A user interface at least displays audio/visual content received from the first station when the audio/visual devices are properly configured. A control device communicates with the audio/visual devices to adjust the audio/visual devices configurations to display the received audio/visual content on the user interface.

According to another aspect, a method is disclosed. Audio/visual content is transmitted to audio/visual devices of a home station. Configuration of the audio/visual devices is controlled to display the audio/visual content, which is received from the first station, on a user interface.

According to another aspect, a control apparatus is disclosed. A control module communicates to a user interface and related audio/visual devices and generates configuration commands to configure the user interface and related audio/visual devices based on predetermined parameters to receive and display on the user interface audio/visual content which is transmitted from a first station.

The invention may take form in various components and arrangements of components, and in various process operations and arrangements of process operations. The drawings are only for the purpose of illustrating preferred embodiments and are not to be construed as limiting the invention.

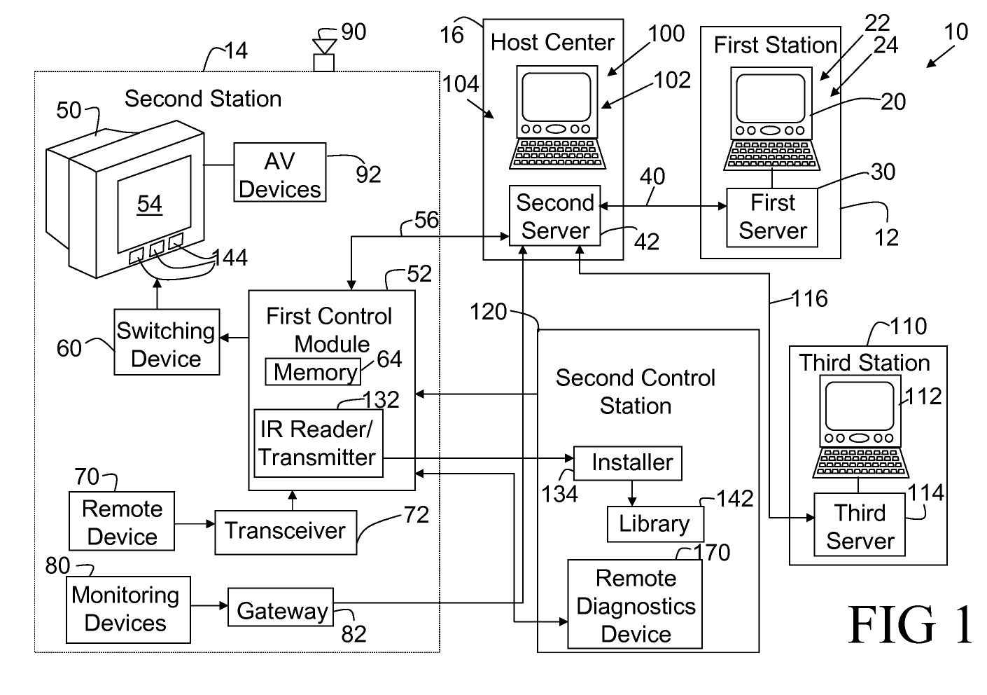

FIG. 1 diagrammatically shows principal components of an example health management system; and

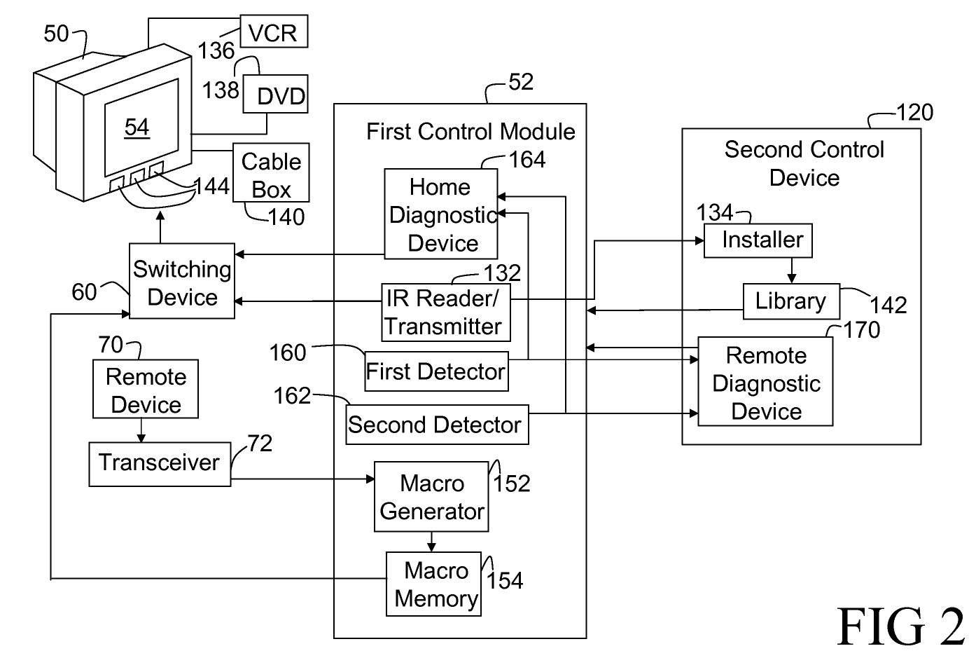

FIG. 2 diagrammatically shows a portion of the health management system.

With reference to FIG. 1, a health management system 10 includes first and second stations 12, 14 and a host center or station 16. The first station 12 is located, for example, at a care provider site such as a physician's office or hospital and includes a terminal 20. One example of the terminal 20 is a personal computer which includes an appropriate software 22, such as user interface software, and hardware 24, for interfacing with the host center 16 and the second station 14. The terminal 20 is connected to a first server 30 via an intranet or other connection as known in the art.

Of course, it is contemplated that the health management system 10 can include a plurality of the first stations 12, a plurality of host centers 16 and a plurality of second stations 14 as appropriate for an application.

A first link 40 provides the connection between the first station 12 and the host center 16. Alternatively, the first station 12 is a wireless station of a wireless local area network (LAN) or wireless wide area network (WAN).

In one embodiment, the second station 14 includes a user interface device or television set 50 which is located in a patient's home or dwelling. A first control module or processor or algorithm or means or device 52, such as set-top box, interfaces with a video display 54. The first control module 52 converts and displays data from analog cable, digital cable, or digital broadcast television to a standard channel frequency, e.g. channel number, for display, for example, on a standard analog television set 50. In one embodiment, the first control module 52 further receives off-air digital television (DTV) signals for display on a DTV monitor. The first control module 52 receives signals such as typical standard television signals and also patient information signals from the host center 16 via a second link 56. The examples of the second link 56 are wired connection, wireless connection, fiber optic connection and the like.

The first control module 52 is connected to the video display 54 via a switching device or algorithm or means 60 such as an audio/video (AV) switching device as known in the art. The switching device 60 provides switching between television reception from the tuner of the display 54 and patient information reception/transmission from/to the host center 16. Alternatively, any other known type of input device adapted to provide an interface to the video display 54 is used.

For example, the patient information signals include information, instructions and queries that are displayed on the video display for information, action, and the like. The patient information signals include video and audio programs, audio programs, video messages and audio messages. For example, the first control module 52 includes a memory 64 so that patient information signals are stored for later use. When the switching device 60 is configured to transmit the patient information signals, the first control module 52 retrieves the patient information signals from the memory 64 to the display 54.

A remote interface device 70 of the second station 14 provides signals to an infrared transceiver 72 via input means 74 such as push buttons. Signals to the transceiver 72 are provided to the first control module 52 and function to provide video input to the video display 54. In one embodiment, the remote interface device 70 is a remote control device such as one commonly used in the home entertainment systems. In another embodiment, the remote interface device 70 is a computer input interface device, such as a keyboard or a mouse.

In one embodiment, the second station 14 includes a set of patient monitoring devices 80. The examples of the patient monitoring devices 80 include a weight scale, a blood pressure device, an electrocardiogram, and the like. Additionally, or alternatively, certain measurements may be manually entered by the patient. Collected monitored or manual patient data are provided to a measurement gateway 82, which transmits the data to the host center 16 for processing and use and, optionally, to the monitor for display. Other examples of routing the collected monitored or manually entered patient data are sending the data directly to the host center 16, sending the data directly to the first station 12, and routing the data through the first control module 52.

Other examples of the user interface devices are personal computer (PC), personal digital assistant (PDA), a mobile phone, a portable computer, and the like. As such, the display can also include a computer monitor, handheld communication device display, such as a portable phone, cellular phone, PDA, and the like.

In one embodiment, the second station 14 includes an RF source 90, such as an antenna, and AV devices 92 which provide links to the second station. The RF source and the AV devices are in operative communication with at least one of the television set 50 and the first control module 52. The examples of the AV devices 92 are a video cassette recorder (VCR), a digital video disc (DVD) player, a cable or satellite box, and the like.

The host center 16 includes appropriate hardware 100, software 102 and communications links 104 to enable connectivity between the first and second stations 12, 14. Of course, it is also contemplated that the first and second stations 12, 14 can be in direct operative communication.

The host center 16 is centralized and includes various servers for specific functions. The examples of servers of the host center 16 are a video server which provides pertinent video programming to the patient, a measurement server which receives data from the measurement gateway 82, and others. However, it is contemplated that the host center 16 is distributed, with different components or sub-centers hosting different functions. Alternatively, there may be a plurality of host centers 16 that connect a plurality of second stations 14 with one or more first stations 12.

Optionally, the health management system 10 includes an information or third station 110 which provides access to the patient information to the authorized users, such as selected doctors, nurses, family members and friends, via an access terminal 112 connected to a third server 114. The examples of the access terminal 112 are a personal computer, a video display including a control module, a PDA, a portable computer, a cellular telephone, and the like. The connection of the third station 110 to the host center 16 may be a third link 116 including wired or wireless connection.

With continuing reference to FIG. 1 and further reference to FIG. 2, a second or remote control station or device or module 120 enables a remote diagnostics and maintenance support of the health management system 10. More specifically, the first control module 52 includes an IR reader/transmitter 132. During initial installation and set up, an installer 134 identifies via the IR reader/transmitter 132 a unique IR operating code of each related audio/video (AV) device 92, with which the television set 50 commonly communicates with, such as VCR 136, DVD 138, cable box 140, and the like, which related AV devices 92 are positioned proximately to the second station 14. An infrared operating code of each identified AV device 92 is stored in a library 142 that is located in the remote control station 120. However, it is also contemplated that the library 142 can be located in the first control module 52, host center 16, first station 14, third station 110, and the like. In the maintenance mode, the remote control module or device 120 sends, for example, the IR commands to the first control module 52 to configure user interface or television components 144 according to the known health care management system configuration. Examples of the user interface components 144 being configured are television channel for viewing the health care content, the audio volume, and the like. In one embodiment, the first control device 52 locally configures user interface or television components 144 according to the known health care management system configuration.

In one embodiment, a macro generator 152 generates macros, by which a single user input to the first control module 52, such as pressing a single button 74 on the remote device 70, automatically activates a set of sequential device commands. For example, in response to the receiving the user input, the first control module 52 sends appropriate IR command or other signals to turn on the television 50, adjust the volume level, set the television 50 to an appropriate channel or video input, set any audio/video switches in the system and the like to a preselected mode of operation. The macros are stored in a macro memory 154.

In one embodiment, the first control device 52 includes at least one of first and second detectors 160, 162. For example, the first detector 160 is a light detector, such as a photosensor, for sensing visual effects. The second detector 162 is a sound detector such as a microphone, for sensing the sound waves. During initial installation, the installer 134 configures each equipment component 144 of the television 50 with a preselected visual sequence, such as blinking of a video pattern, and/or audio sequence, such as modulated test tone, which each is characteristic of a normal operation. In the maintenance mode, for one example, the first detector 160 senses whether the television 50 displays a preselected visual pattern on the display 54. As another example, the second detector 162 senses whether the television 50 outputs a preselected audio pattern, and the like. For example, a home diagnostic module or device 164 steps the television 50 through a predetermined maintenance sequence. Based on the signals sensed by the first and second detectors 160, 162, the first control module 52 adjusts configuration of the television set 50. In one embodiment, a remote diagnostic device 170 steps the first control module 52 through a predetermined maintenance sequence, receives signals from at least one of the first and second detectors 160, 162, and makes a synchronous determination which equipment component is malfunctioning or improperly configured. In the case when the equipment malfunction or incorrect configuration is determined, the remote diagnostic device 170 automatically steps the first control module 52 through, for example, video inputs until the proper health care management system video and audio combination is achieved. In one embodiment, the service technician accesses the first control device 52 via the remote control device 120 to send out appropriate control signals to various audio/video components and monitors the television 50 for appropriate response. It is also contemplated that the maintenance sequence can be initiated via the patient input, physician input such as when the information is sent, host center input, third party input at the third station 110, or on a periodic basis.

Optionally, the remote diagnostic device 170 can check impedance or other electrical properties of associated cables to determine loose or missing connections.

In this manner, the first control module 52 and/or remote control station 120 exercise control over a patient's TV set and associated audio/video equipment. The home health management system is maintained cost effectively by remote personnel. The total support time spent by the service personnel is substantially reduced.

The invention has been described with reference to the preferred embodiments. Obviously, modifications and alterations will occur to others upon reading and understanding the preceding detailed description. It is intended that the invention be construed as including all such modifications and alterations insofar as they come within the scope of the appended claims or the equivalents thereof.

1. An audio/visual management system (10) comprising:
a first station (12, 16) which at least sends audio/visual content to audio/visual devices (50, 92), which include:
a user interface (50) which at least displays audio/visual content received from the first station (12, 16) when the audio/visual devices (50, 92) are properly configured; and
a control device (52, 120) which communicates with the audio/visual devices and adjusts configurations of the audio/visual devices (50, 92) to display the received audio/visual content on the user interface (50).

2. The system as set forth in claim 1, further including:
a library (142) in which an identification of each audio/visual device (50, 92) is stored.

3. The system as set forth in claim 2, wherein the configurations of the audio/visual devices are controlled by infrared signals and further including:
an infrared reader/transmitter (132) which receives a unique infrared operating code of each audio/visual device (50, 92) and stores each identified infrared operating code in the library (142) and which transmits instructions for changing the configurations of the audio/visual devices.

4. The system as set forth in claim 2, wherein the control device (52, 120) includes:
a first control module (52) which receives the audio/visual content from the first station (12, 16) and communicates the audio/visual content to the audio/visual devices (50, 92) for display on the user interface (50) when the audio/visual devices (50, 92) are properly configured; and
a second control module (120) which remotely withdraws the identification of each audio/visual device (50, 92) from the library (142) and communicates to the first control module (52) the configuration commands to configure the audio/visual devices (50, 92) based on selected parameters.

5. The system as set forth in claim 1, further including:
a remote device (70) which includes user inputs (74) and which configures the audio/visual devices (50, 92) in response to sequential activation of one or more user inputs (74).

6. The system as set forth in claim 5, further including:
a macro generator (152) which generates a sequence of configuration commands which put the audio/visual devices (50, 92) in preselected configurations and which sequence is executed automatically responsive to the activation of a single user input (74).

7. The system as set forth in claim 1, further including:
at least one detector (160, 162) which detects at least one of audio and visual output signals of the user interface (50).

8. The system as set forth in claim 7, further including at least one of:
a home diagnostic module (164) which controls the user interface (50) to transmit preselected audio or visual content by stepping the audio/visual devices (50, 92) through a predetermined cycle sequence, and determines, based on the detected audio or visual signals, a malfunctioning or improperly configured component of at least the user interface (50); and
a remote diagnostic device (170) which is connected with the at least one detector (160, 162) to control the user interface (50) to transmit preselected audio or visual content by stepping the first control module (52) through a predetermined cycle sequence, and determines, based on the detected audio or visual signals, a malfunctioning or improperly configured component of at least the user interface (50).

9. The system as set forth in claim 8, wherein the transmission of the preselected audio or visual content is initiated by at least one of:
a patient input,
an automatic trigger,
a predetermined timer, and
a remote input.

10. The system as set forth in claim 1, wherein the audio/visual content includes health content customized to a patient at a home station (14) and further including:
a monitoring device (80) which monitors a physiological parameter of the patient and transmits the monitored parameter from the home station (14) to the first station (12, 16) for medical professional review.

11. A method comprising:
transmitting audio/visual content to audio/visual devices (50, 92) of a home station (14); and
controlling configuration of the audio/visual devices to display the audio/visual content, which is received from the first station, on a user interface.

12. The method as set forth in claim 11, further including:
storing a unique infrared identification of each audio/visual device in a library;
withdrawing the identifications of the audio/visual devices from the library; and
configuring the audio/visual devices based on the withdrawn identifications and preselected parameters.

13. The method as set forth in claim 11, further including:
generating a sequence of configuration commands for the audio/visual devices;
storing the sequence; and
automatically executing the stored sequence responsive to the activation of a single user input.

14. The method as set forth in claim 11, further including:
sensing at least one of visual and audio output from the user interface;
communicating the sensed visual or audio output to a remote maintenance station to provide at least one of audio and visual feedback.

15. The method as set forth in claim 11, wherein the step of controlling configuration of the audio/visual devices includes:
executing a maintenance sequence which includes:
instructing the user interface to transmit preselected audio or visual content;
sensing at least one of visual and audio output signals from the user interface; and
based on the sensed audio or visual output signals, identifying a malfunctioning component of at least the user interface (50).

16. The method as set forth in claim 16, wherein the execution of the maintenance sequence is initiated by at least one of:
a patient input,
an automatic trigger,
a predetermined timer, and
a remote input.

17. The method as set forth in claim 11, wherein the audio/visual content includes health content customized to a patient at the home station and further including:
monitoring a physiological parameter of the patient and transmitting the monitored parameter from the home station to a remote medical station for medical professional review.

18. A control apparatus comprising:
a control module (52, 120) which communicates to user interface (50) and related audio/visual devices (92) and generates configuration commands to configure the user interface (50) and related audio/visual devices (92) based on predetermined parameters to receive and display on the user interface (50) audio/visual content which is transmitted from a first station (12, 16).

19. The apparatus as set forth in claim 18, wherein the configurations of the user interface and audio/visual devices are controlled by infrared signals and further including:
an infrared reader/transmitter (132) which receives a unique infrared operating code of the user interface and each related audio/visual device (92) and stores each identified infrared operating code in a library (142) and which transmits instructions for changing the configurations of the audio/visual devices.

20. The apparatus as set forth in claim 18, further including:
at least one detector (160, 162) which detects at least one of audio and visual preselected output signal sequence of the user interface (50), based on which detection the control module (52, 120) properly configures the user interface to display the received audio/visual content.
